(19) United States
(12) Patent Application Publication
(10) Pub. No.: US 2009/0295102 A1
(43) Pub. Date: Dec. 3, 2009

(54) Formed in place over-mold seal

(76) Inventor: Daniel A. McKenzie, Glenn Williams (CA)

Correspondence Address: DANIEL A. MCKENZIE, 12124 8TH LINE, GLEN WILLIAMS, ON, L7G 4R7, CA

(21) Appl. No.: 12/156,348

(22) Filed: Jun. 2, 2008

(51) Int. Cl. F16L 21/02

(52) U.S. Cl. 277/617

(57) ABSTRACT

This disclosure relates to all plastic drain, waste and vent fittings whereas an annular formed in place over-mold seal is part of the fittings.

This annular formed in place over-mold seal that has internal lips of multiple designs, provides a seal against the outer surface of the pipe being inserted and allows for slight misalignment, expansion and easy assembly.

It is a one step bonding process of the same material that reduces both manufacturing assembly and material.

This formed in place over-mold seal is of the same material as the fitting but has a softer composition.

### BACKGROUND OF INVENTION

The present situation for seals on the plastic waste drain and vent pipes involves a three piece system—the bell of the pipe, the seal and the seal holding device.

The formed in place over-mould seal is a one step process that is a complete fitting when molded.

The formed in place over-mold seal reduces the manufacturing costs, material used and any labor used for assembly

In reference to U.S. Pat. No. 1,979,470 by J. C. Johnston you will find that the two seals—one on each member—will require assembly to install the seals onto the spigot and into the bell. The casting of the spigot and bell will be another process to produce the seal seat into the annular bell grove and spigot grove

In reference to U.S. Pat. No. 3,592,481 by Warren C. Jeffery, the problem of assemble still exists as well as the casting, molding or machining of the annular grove inside the bell. These problems also exists on U.S. Pat. Nos. 3,741,57 by Garrett, 4,084,827 by Wolf, 4,097,074 by Nagao, 4,268,046 by Nisper, 4,288,104 by Nordin, 6,193,238 B1 by Sporre, 6,457,718 B1 by Quesada and 7,252,293 B2 by Happel.

In reference to U.S. Pat. No. 6,328,310 B1 by Chikaraishi, there is still the cost of assembly of the seal and injection of the air into the seal.

In reference to U.S. Pat. No. 5,951,022 by Gorman, the assembly and manufacturing of the seal and seal holding parts is a major labor problem.

In reference to U.S. Pat. No. 3,961,814 by Byrne, the seal and assembly has to be heated after the pipe is joined. This is a time consuming assembly and requires special tools.

In reference to U.S. Pat. No. 5,143,381 by Temple, each spigot end of the pipe has to be machine for the seal, making it time consuming and laborious.

### DESCRIPTION OF INVENTION

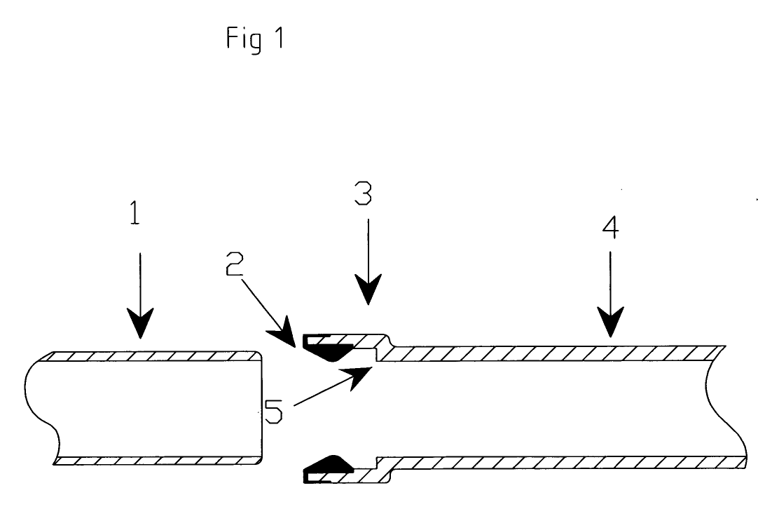

FIG. 1

Each bell (3) of the fitting (4) will have the formed in place over-mold seal (2) and by simply pushing the pipe spigot (1) into the bell (3), will cause the formed in place over-mold seal (2) to compress itself against the outer wall of the pipe spigot.

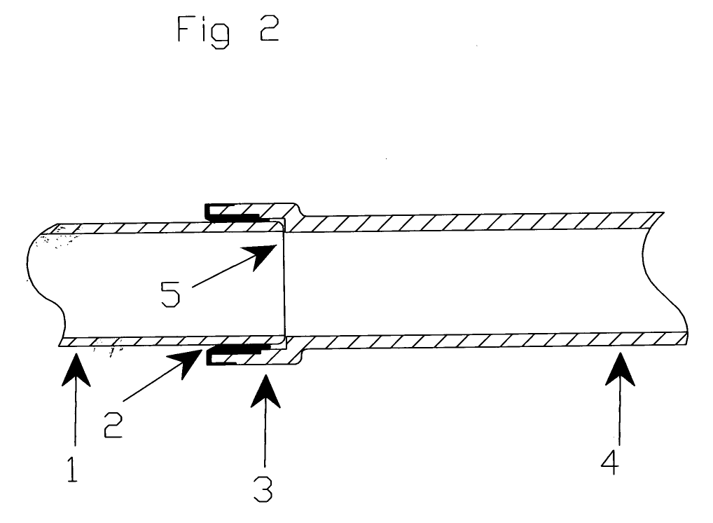

FIG. 2

The pipe spigot (1) has entered the bell (3) and compressed the formed in place over-mold seal (2) against the pipe spigot (1) and the bell (3) thus causing sealing.

The pipe spigot (1) will be limited to depth by an internal shoulder (5).

### DISCLOSURE OF THE INVENTION

The invention is directed to an improvement over the present day art of sealing systems that are comprised of two or more pieces.

This formed in place over-mold seal is bonded molecularly when molded onto the same material as the fitting.

This formed in place over-mold seal can be of multiple seal lip designs.

It is an object of the invention to reduce time, assembly and material of sealing plastic waste, drain and vent pipes

I claim:

1. A formed in place over-mold seal, for plastic fittings such as drain, waste and vent fittings.
